(19) United States
(12) Patent Application Publication
(10) Pub. No.: US 2023/0327094 A1
(43) Pub. Date: Oct. 12, 2023

(54) ANODE FOR LITHIUM SECONDARY BATTERY COMPRISING AN INTERFACIAL LAYER AND MANUFACTURING METHOD THEREOF

(71) Applicants: HYUNDAI MOTOR COMPANY, Seoul (KR); KIA CORPORATION, Seoul (KR); THE BOARD OF TRUSTEES OF THE LELAND STANFORD JUNIOR UNIVERSITY, Stanford, CA (US)

(72) Inventors: Samuel Seo, Yongin-si (KR); Won Keun Kim, Seoul (KR); Jong Chan Song, Suwon-si (KR); Kyoung Han Ryu, Yongin-si (KR); Yeon Jong Oh, Seoul (KR); Zhenan Bao, Stanford, CA (US); Zhiao Yu, Stanford, CA (US)

(73) Assignees: Hyundai Motor Company, Seoul (KR); Kia Corporation, Seoul (KR); THE BOARD OF TRUSTEES OF THE LELAND STANFORD JUNIOR UNIVERSITY, Stanford, CA (US)

(21) Appl. No.: 17/978,593

(22) Filed: Nov. 1, 2022

Related U.S. Application Data
(60) Provisional application No. 63/328,365, filed on Apr. 7, 2022.

(51) Int. Cl. H01M 4/40; H01M 4/04; H01M 4/62

(52) U.S. Cl. CPC H01M 4/405; H01M 4/0404; H01M 4/622; H01M 2004/027

(57) ABSTRACT

The present disclosure relates to a lithium secondary battery anode provided with an interfacial layer including a coordination compound and a method of manufacturing the same. The anode may include an anode current collector layer, an anode material layer disposed on the anode current collector layer and including lithium metal, and an interfacial layer disposed on the anode material layer and including a coordination compound.

The present application claims priority to U.S. Patent Application No. 63/328,365, filed Apr. 7, 2022, the entire contents of which is incorporated herein for all purposes by this reference.

### TECHNICAL FIELD

The present disclosure relates to an anode for a lithium secondary battery provided with an interfacial layer including a coordination compound and to a method of manufacturing the same.

### BACKGROUND

A lithium metal battery uses lithium metal as an anode material. A lithium metal battery has a higher energy density than a lithium ion battery using an anode active material such as graphite or silicon. However, lithium metal batteries have problems in that lithium dendrites growth during charging and discharging, so that charging and discharging efficiency is lowered or short-circuit is occurred. In addition, a side reaction between the lithium metal and the electrolyte occurs, resulting in an increase in the surface resistance. This makes the redox reaction non-uniform, thereby deteriorating the reversibility of charging and discharging.

A protective film is famed on the lithium metal to solve the above problem of the lithium metal battery. However, conventional protective film has disadvantages such as low lithium ion conductivity, failure to completely block the electrolyte, and increasing costs of materials and manufacturing.

### SUMMARY

An objective of the present disclosure is to provide an anode for a lithium secondary battery being excellent in mechanical properties such as Young's modulus and hardness, thereby inhibiting lithium dendrites growth, and a method of manufacturing the same.

Another objective of the present disclosure is to provide an anode for a lithium secondary battery having excellent lithium ion conductivity.

A further objective of the present disclosure is to provide a stable anode for a lithium secondary battery without reacting with an electrolyte.

A yet further objective of the present disclosure is to provide an anode for a lithium secondary battery anode capable of being manufactured through a solution process.

However, the objectives of the present disclosure are not limited the one described above. The objectives of the present disclosure will become more apparent from the following description and will be realized with components recited in the claims and combinations of the components.

According to one embodiment of the present disclosure, an anode for a lithium secondary battery may include: an anode current collector layer; an anode material layer disposed on the anode current collector layer and including lithium metal; and an interfacial layer disposed on the anode material layer and including a coordination compound, in which the coordination compound may include a complex ion and a counter ion, the complex ion may include a central cation and a ligand coordinated to the central cation and including a fluorocarbon moiety having 1 to 4 of carbon atoms, and the counter ion may include a lithium ion.

The coordination compound may have a crystalline or semicrystalline structure.

The coordination compound may have an orthorhombic crystal structure.

The complex ion may comprise a plurality of central cations connected to each other via the ligand.

The central cation may include a cation of a metal, and the metal may include at least one of Al, Zn, Co, Ni, Cu, Fe, or any combination thereof.

The central cation may include Al³⁺.

The coordination compound may include an amount of about 2% to 7% by weight of the counter ion.

The interfacial layer may have a Young's modulus of about 30 GPa to 40 GPa and a hardness of about 2 GPa or higher.

The interfacial layer may have a lithium ion conductivity of about 9×10⁻⁶ S/cm or more.

The interfacial layer may exhibit a peak at a binding energy of about 531 ev to 534 eV in O1s spectrum of X-ray photoelectron spectroscopy (XPS) analysis.

The interfacial layer may exhibit a peak at a binding energy of 685 eV to 687 eV in F1s spectra of X-ray photoelectron spectroscopy (XPS) analysis.

According to one embodiment of the present disclosure, there is provided a method of manufacturing an anode for a lithium secondary battery, the method may include: preparing a solution including a coordination compound by adding a precursor of the coordination compound to a solvent and reacting the precursor; forming an interfacial layer by coating the solution onto a substrate and drying the solution; and manufacturing an anode including an anode current collector layer, an anode material layer disposed on the anode current collector layer and including a lithium metal, and the interface layer disposed on the anode material layer.

The precursor may include a first reactant including a precursor of the central cation and a precursor of the counter ion.

The precursor may include a second reactant including a precursor of the ligand.

The first reactant may include a compound represented by LiMHₓ, in which M includes at least one of Al, Zn, Co, Ni, Cu, Fe, or any combination thereof, and x is the valence number of M.

The second reactant may include a compound represented by Formula 1.

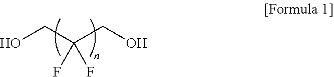

wherein n may be an integer of 1 to 4.

The solvent may include at least one of a 1.2-dimethoxyethane, tetrahydrofuran, or any combination thereof.

According to the present disclosure, it is possible to provide an anode for a lithium secondary battery being excellent in mechanical properties such as Young's modulus and hardness, thereby inhibiting lithium dendrites growth, and to provide a method of manufacturing the same.

According to the present disclosure, it is possible to provide an anode for a lithium secondary battery having excellent lithium ion conductivity.

According to the present disclosure, it is possible to provide a stable anode for a lithium secondary battery without reacting with an electrolyte.

According to the present disclosure, it is possible to easily manufacture an anode for a lithium secondary battery by using a solution process.

However, the advantages of the present disclosure are not limited thereto. It should be understood that the advantages of the present disclosure include all effects that can be inferred from the description given below.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 shows a lithium secondary battery according to the present disclosure;

FIG. 2 shows a coordination compound according to the present disclosure;

FIG. 3 shows a crystal structure obtained by single crystal X-ray diffraction (SCXRD) of the coordination compound according to the present disclosure;

FIG. 4 shows a method of manufacturing an anode for a lithium secondary battery, according to the present disclosure;

FIG. 5A shows a crystalline coordination compound obtained in Preparation Example;

FIG. 5B shows a solution obtained by dissolving the coordination compound obtained in Preparation Example in 1,2-dimethoxyethane (DME);

FIG. 6 shows a crystal structure obtained by single crystal X-ray diffraction (SCXRD) of the coordination compound obtained in Preparation Example;

FIG. 7A shows Young's modulus (Young's modulus) of an interfacial layer obtained in Preparation Example;

FIG. 7B shows hardness of the interfacial layer obtained in Preparation Example;

FIG. 8A shows a Nyquist plot obtained by analyzing a symmetric cell according to Comparative Example 1 by electrochemical impedance spectroscopy;

FIG. 8B shows a Nyquist plot obtained by analyzing a symmetric cell according to Example 1 by electrochemical impedance spectroscopy;

FIG. 9A shows an O1s spectrum obtained by analyzing the symmetric cell according to Comparative Example 1 by X-ray photoelectron spectroscopy (XPS);

FIG. 9B shows an F1s spectrum obtained by analyzing the symmetric cell according to Comparative Example 1 by X-ray photoelectron spectroscopy;

FIG. 10A shows an O1s spectrum obtained by analyzing the symmetric cell according to Example 1 by X-ray photoelectron spectroscopy;

FIG. 10B shows an F1s spectrum obtained by analyzing the symmetric cell according to Example 1 by X-ray photoelectron spectroscopy;

FIG. 11A shows cycling performance of the symmetric cells according to Example 1 and Comparative Example 1;

FIG. 11B shows periodic performance of a specific period shown in FIG. 11A;

FIG. 12 shows a scanning electron microscope (SEM) image of lithium deposited in a half cell according to Comparative Example 2;

FIG. 13A shows an SEM image of lithium deposited in a half cell according to Example 2;

FIG. 13B shows analysis result for fluorine atoms by an energy-dispersive X-ray spectroscopy (EDS) to the half cell of Example 2;

FIG. 13C shows analysis result for aluminium atoms by an energy-dispersive X-ray spectroscopy (EDS) to the half cell of Example 2;

FIG. 14 shows cycling performance of the symmetric cells according to Example 2 and Comparative Example 2;

FIG. 15 shows coulombic efficiency of half cells according to Example 2 and Comparative Example 2;

FIG. 16 shows cycling performance of full cells according to Example 3 and Comparative Example 3; and

FIG. 17 shows coulombic efficiency of full cells according to Example 3 and Comparative Example 3.

### DETAILED DESCRIPTION

Above objectives, other objectives, features, and advantages of the present invention will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art.

Throughout the drawings, like elements are denoted by like reference numerals. In the accompanying drawings, the dimensions of the structures are larger than actual sizes for clarity of the present disclosure. Tams used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise.

It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

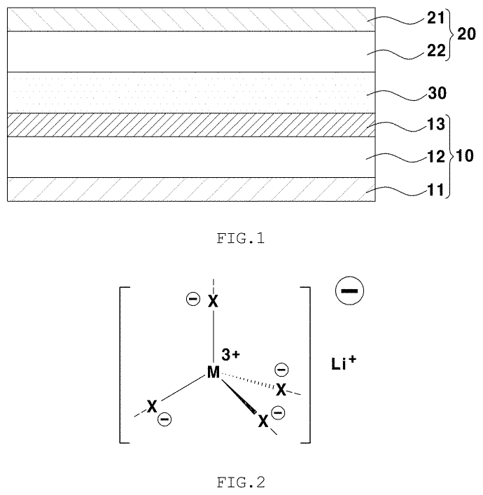

FIG. 1 shows a lithium secondary battery 1 according to one embodiment of the present disclosure. The lithium secondary battery 1 may include an anode 10, a cathode 20, and an electrolyte 30 interposed between the anode 10 and the cathode 20.

The anode 10 may include an anode current collector layer 11, an anode material layer 12 disposed on the anode current collector layer 11, and an interfacial layer 13 disposed on the anode material layer 12.

The anode current collector layer 11 may be an electrically conductive plate-shaped substrate. Specifically, the anode current collector layer 11 may be in the form of a sheet, a thin film, or a foil.

The anode current collector layer 11 may include a material that does not react with lithium. Specifically, the anode current collector layer 11 may include at least one of Ni, Cu, stainless steel (SUS), or any combination thereof.

The anode material layer 12 may include lithium metal or lithium alloy.

The lithium alloy may include lithium, and a metal or metalloid capable of alloying with lithium.

The metal or metalloid capable of alloying with lithium may include Si, Sn, Al, Ge, Pb, Bi, Sb, or the like.

Lithium metal has a large capacity per unit weight, which is advantageous for realization of high-capacity batteries. However, lithium dendrites may grow during lithium ion deposition and dissolution process to cause a short circuit between the cathode 20 and the anode 10. In addition, since lithium metal is highly reactive to an electrolyte, the lifespan of a battery may be reduced due to a side reaction therebetween. On the other hand, since lithium metal exhibits a large volume change during the charging and discharging processes, deintercalation may occur.

Accordingly, an embodiment of the present disclosure prevents the above problems by forming the interfacial layer 13 on the anode material layer 12.

The interfacial layer 13 may include a coordination compound including complex ions and counter ions. FIG. 2 shows the coordination compound. The coordination compound may include: a central cation; and an anion cluster including ligands coordinated to the central cation, and counter ions.

The coordination compound may be a compound having a crystalline or semicrystalline structure. Here, the term “semi-crystalline” may refer to a state in which a crystalline region and an amorphous region are mixed. When the coordination compound exhibits a semicrystalline structure, the coordination compound may include 50% or more, or 60% or more, or 70% or more, or 80% or more, or 90% or more, or 95% or more of a crystalline region.

The coordination compound may be a compound having an orthorhombic crystal structure. When the coordination compound exhibits a semi-crystalline crystal structure, the crystalline region may be a region having an orthorhombic crystal structure.

Since the coordination compound exhibits crystallinity, the interfacial layer 13 has a high Young's modulus and a high hardness. Therefore, the interfacial layer 13 may effectively inhibit lithium dendrite growth on the anode material layer 12.

FIG. 3 shows a crystal structure obtained by performing single crystal X-ray diffraction (SCXRD) to the coordination compound. In FIG. 3, “Al” may refer to a central cation, “FBD” may refer to a ligand, “Li” may refer to a counter ion, and “DME” may refer to a solvent used to form the coordination compound. An example of the coordination compound may a compound represented by Li₃Al₃(FBD)₆(DME)₃.

Referring to FIG. 3, the complex ion may be formed such that a plurality of central cations are connected to each other via the ligands to form an anion cluster.

The central cation may include a cation of a transition metal and/or a post-transition metal. Specifically, the central cation may include a cation of a metal selected from the group consisting of Al, Zn, Co, Ni, Cu, Fe, and combinations thereof. preferably, the central cation may include Al³⁺.

The ligand may include linear carbon fluoride. Specifically, the ligand may include a fluorocarbon moiety having 1 to 4 carbon atoms. By using low-carbon-numbered, linear, and fluorinated ligands, it is possible to increase the content of counter ions in the coordination compound and to prevent the electrolyte 30 from penetrating the interfacial layer 13 and contacting the anode material layer 12.

The counter ions may include lithium ions. The counter ions may move in a manner of hopping between the complex ions adjacent to each other due to electrostatic attraction. Thus, the coordination compound may constitute an ion conductive network within the interfacial layer 13.

The shorter the distance between the complex ions and the higher the content of the counter ions, the faster the conduction of the counter ions occur. As described above, since the complex ion in the present disclosure includes low-carbon-numbered ligands, the complex ions can be present at a high density (or concentration) in the interfacial layer 13. Therefore, it is possible to obtain the interfacial layer 13 having a high counter ion conductivity. Specifically, the coordination compound may include the counter ions in an amount of about 2% or more by weight, or about 3% or more by weight, or about 4% or more by weight. In addition, the coordination compound may include the counter ions in an amount of up to about 5% by weight, or up to about 7% by weight.

The interfacial layer 13 may have a lithium ion conductivity of about 9×10⁻⁶ S/cm or more. The upper limit of the lithium ion conductivity is not particularly limited, but it may be about 10⁻⁴ S/cm or less, or about 10⁻³ S/cm or less. The lithium ion conductivity may be a value measured at room temperature (about 25° C.)

The thickness of the interfacial layer 13 may range from about 10 nm to 100 μm, or about 50 nm to 50 μm, or about 200 nm to 3 μm, or about 500 nm to 3 μm. When the thickness of the interfacial layer 13 is smaller than 10 nm, it is difficult to suppress the growth of dendritic lithium. When the thickness of the interfacial layer 13 is larger than 100 μm, the lithium ion conductivity decreases or the interfacial layer 13 acts as a resistor in the cell.

The interfacial layer 13 may be a monolayer structure or a multilayer structure. When the interfacial layer 13 is a multilayer layer structure, each layer may include the coordination compound, and the overall thickness of the interfacial layer 13 may fall within the numerical range described above.

The cathode 20 may include a cathode active material, a binder, and a conductive material.

The cathode active material may include at least one selected from the group consisting of lithium cobalt oxide, lithium nickel cobalt manganese oxide, lithium nickel cobalt aluminum oxide, lithium iron phosphate, lithium manganese oxide, and combinations thereof. However, the cathode active material is not limited thereto, and all cathode active materials available in the art may be used.

The binder may bond the cathode active material and the conductive material. The binder may include polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluororubber, various copolymers, etc.

The conductive material is not particularly limited if it has conductivity without causing a chemical change in the battery. For example, The conductive material may include: graphite such as natural graphite or artificial graphite; carbon-based substances such as carbon black, acetylene black, Ketjen black, channel black, furnace black, lamp black, and summer black; conductive fibers such as carbon fibers and metal fibers; powder of metal such as carbon fluoride, aluminum, and nickel; conductive whiskers of zinc oxide and potassium titanate; conductive metal oxides such as titanium oxide; and conductive materials such as polyphenylene derivatives.

The electrolyte 30 may conduct lithium ions between the anode 10 and the cathode 20. The electrolyte 30 may include an electrolyte solution, a lithium salt, and an organic fluorine compound.

The electrolyte solution may include an organic solvent. Any solvent can be used without limited if it is usable in a lithium secondary battery. For example, ethylenecarbonate, dimethylcarbonate, diethylcarbonate, ethylmethylcarbonate, fluoroethylenecarbonate, 1,2-dimethoxy ethane, 1,2-diethoxyethane, dimethyleneglycoldimethylether, trimethyleneglycoldimethylether, triethyleneglycoldimethylether, tetraethyleneglycoldimethylether, polyethyleneglycoldimethylether, succinonitrile, sulforane, dimethylsulfone, ethylmethylsulfone, diethylsulfone, adiponitrile, 1,1,2,2-tetrafluoroethyl 2,2,3-tetrafluoropropyl ether, dimethylacetamide, or the like may be used.

Any lithium salt can be used without limited if it can be used in a lithium secondary battery. For example, The lithium salt may include LiNO₃, LiPF₆, LiBF6, LiClO₄, LiCF₃SO₃, LiBr, LiI, and the like.

The electrolyte 30 may be impregnated in a separator (not illustrated). The separator may be made of polyethylene, polypropylene, polyalkylene, or the like.

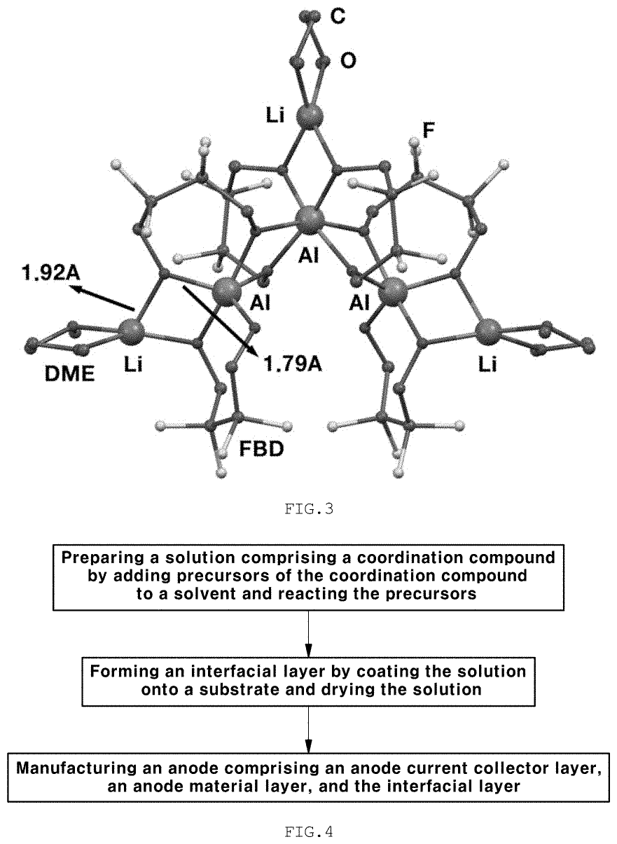

FIG. 4 shows a method of manufacturing the anode for the lithium secondary battery. The method may include: step S10 of preparing a solution including a coordination compound by adding a precursor of the coordination compound to a solvent and reacting the precursor; step S20 of forming an interfacial layer 13 by coating the solution to a substrate and drying the solution; and step S30 of manufacturing an anode including an anode current collector layer 11, an anode material layer 12 disposed on the anode current collector layer 11, and the interfacial layer 13 disposed on the anode material layer 12.

The precursor may include a first reactant including a precursor of the central cation and a precursor of the counter ion, and a second reactant including a precursor of the ligand.

The first reactant may include a compound represented by LiMHₓ, in which M may include at least one selected from the group consisting of Al, Zn, Co, Ni, Cu, Fe, and combinations thereof, and x is the valence number of the M. Preferably, the first reactant may include LiAlH₃.

The second reactant may include a compound represented by Formula 1.

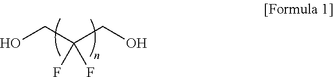

wherein n may be an integer of 1 to 4.

The second reactant may include at least one selected from the group consisting of 2,2-difluoro-1,3-propanediol (2,2-Difluoro-1,3-propanediol, FPrD), 2,2,3,3-tetrafluoro-1,4-butanediol (2,2,3,3-Tetrafluoro-1,4-butanediol, FBD), 2,2,3,3,4,4-hexafluoro-1,5-pentanediol (2,2,3,4,4-Hexafluoro-1,5-pentanediol), 2,2,3,4,5,5-octafluoro-1,6-hexanediol (2,2,3,3,4,4,5,5-Octafluoro-1,6-hexanediol), and combinations thereof.

The solvent may include at least one selected from the group consisting of a 1.2-dimethoxyethane (DME), tetrahydrofuran (THF), and a combination thereof.

When the precursors are added to the solvent and then stirred at a temperature of about 25° C. to be reacted (step S10), a solution containing the coordination compound is obtained. That is, according to the present disclosure, it is possible to form the interfacial layer 13 through a solution process that is advantageous for mass production. In addition, since the by-products from the reaction of the precursors are only hydrogen (H₂), it is easy to dispose the by-products.

When the solution is applied to the substrate and dried, the interfacial layer 13 including a crystalline coordination compound is obtained (step S20).

The solution may be applied to the substrate as it is. Alternatively, the solution may be dried and stored as a powdery coordination compound, then the powdery coordination compound may be put into a solvent to be redispersed (i.e., to become the solution), and then resulting solution may be applied to the substrate before use.

The substrate may include a release film or the anode material layer 12. That is, after the solution is applied to the release film to prepare the interfacial layer 13, the interfacial layer 13 may be transferred to the anode material layer 12, or the solution may be directly applied to the anode material layer 12 to form the interfacial layer 13 on the active material layer 12.

The method of applying the solution is not particularly limited, and spin coating, drop casting, or the like may be used.

The solution may be applied and then dried at a temperature of about 100° C. or less to prepare the interfacial layer 13.

A method of manufacturing the anode including the anode current collector layer 11, the anode material layer 12, and the interfacial layer 13 is not particularly limited. For example, the interfacial layer 13 may be formed on one surface of the anode material layer 12 and then the anode current collector layer 11 may be attached to another surface of the anode material layer 12.

A lithium secondary battery may be manufactured by injecting an electrolyte 30 between the anode 10 and the cathode 20. For example, a stack including the anode 10, the separator (not illustrated), and the cathode 20 may be prepared, and the electrolyte may be injected to the separator.

Hereinafter, embodiments provided by the present disclosure will be described in more detail with reference to examples and comparative examples described below. However, the technical idea of the present disclosure is not limited thereto.

### PREPARATION EXAMPLE

LiAlH₃ as a first reactant and 2,2,3,3-tetrafluoro-1,4-butanediol (FBD) as a second reactant were put into 1,2-dimethoxyethane (DME) as a solvent so that a reaction was caused at room temperature. Hexane was added to terminate the reaction and then the resultant was dried to remove residual solvent.

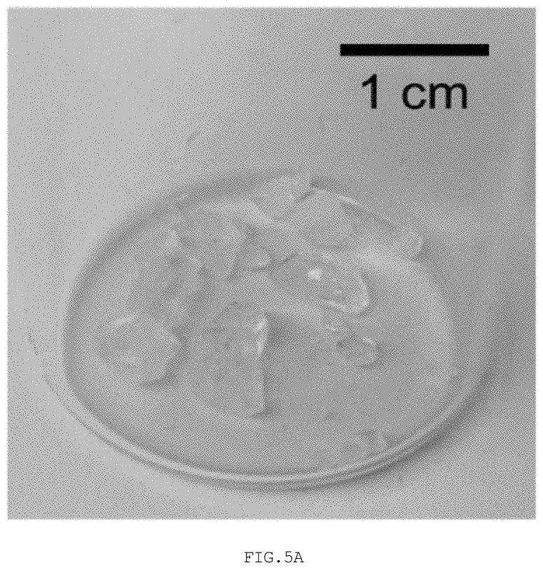

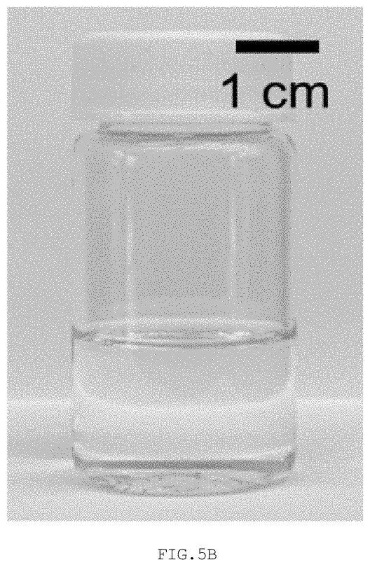

FIG. 5A shows a crystalline coordination compound obtained in Preparation Example. The coordination compound may be obtained in a powder state. The coordination compound in the powder state may be in a size of from millimeter (mm) to centimeter (cm). The size of the coordination compound can be adjusted via the amount of solvent dried.

FIG. 5B shows a solution obtained by dissolving the coordination compound obtained in Preparation Example in 1,2-dimethoxyethane (DME). It is seen that the coordination compound is completely dissolved to form a transparent solution. This transparent solution can be formed in a solution process.

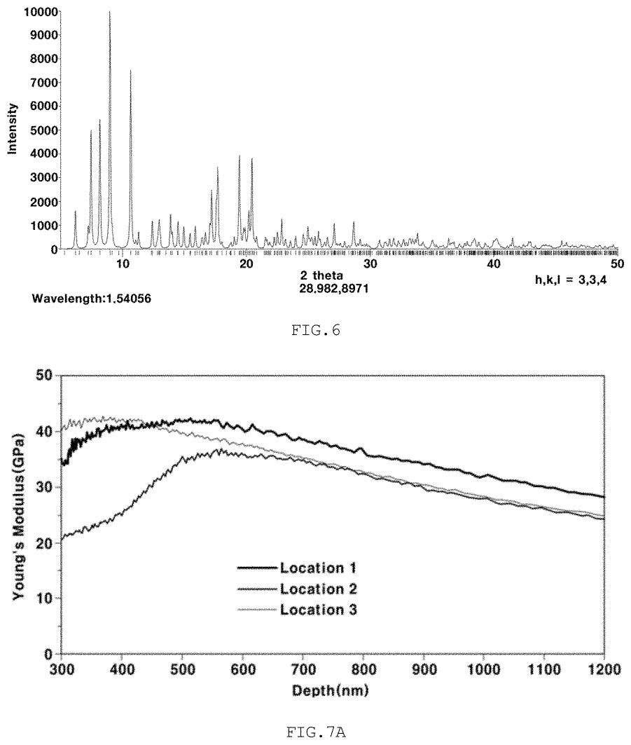

FIG. 6 shows a crystal structure obtained by single crystal X-ray diffraction (SCXRD) of the coordination compound obtained in Preparation Example. This confirmed that the coordination compound is a compound represented by Li₃Al₃(FBD)₆(DME)₃ and has an orthorhombic crystal structure.

The solution was applied onto a substrate and dried to form an interfacial layer. FIG. 7A shows Young's modulus of the interfacial layer. FIG. 7B shows hardness of the interfacial layer. The Young's modulus and hardness were measured through an instrumented nanoindentation test. The Young's modulus and hardness of the interfacial layer were measured by compressing spiked particles at very small loads and deforming the interfacial layer to a depth of less than or equal to micrometers.

Referring to FIGS. 7A and 7B, the interfacial layer exhibits a Young's modulus of about 30 GPa to 40 GPa and a hardness of about 2 GPa to 2.5 GPa. The Young's modulus and hardness are values in a stable region. It is generally known that the growth of dendritic lithium can be inhibited when the Young's modulus is greater than or equal to about 4 GPa. Therefore, the interfacial layer according to the present disclosure can sufficiently inhibit the growth of dendritic lithium on the anode material layer.

### Example 1: Li|Li Symmetric Cell

A lithium metal having a thickness of about 750 μm was prepared as an anode material layer. The solution of FIG. 5B obtained in Preparation Example was applied onto the lithium metal and dried to form the interfacial layer. A pair of the lithium metal, each having the interfacial layer, were attached to both surfaces of a separator, and an electrolyte was injected into the separator to obtain a symmetric cell. The electrolyte was prepared by adding about 10% by weight of fluoroethylene carbonate (FEC) and about 2% by weight of vinylene carbonate (VC) to a mixture of 1M LiPF₆ in ethylene carbonate (EC) and dimethyl carbonate (DEC) (v:v=about 1:1).

### Comparative Example 1

A symmetric cell was prepared in Example 1 except that the interfacial layer was not formed.

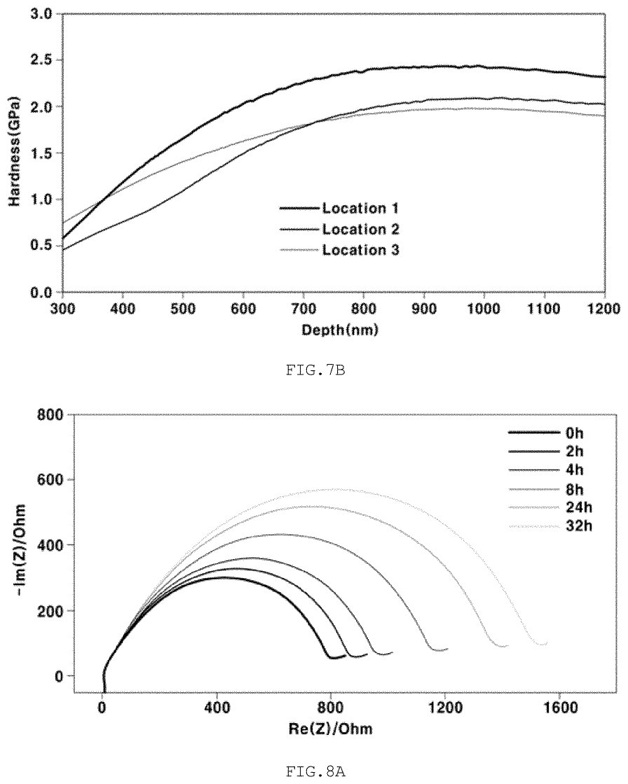

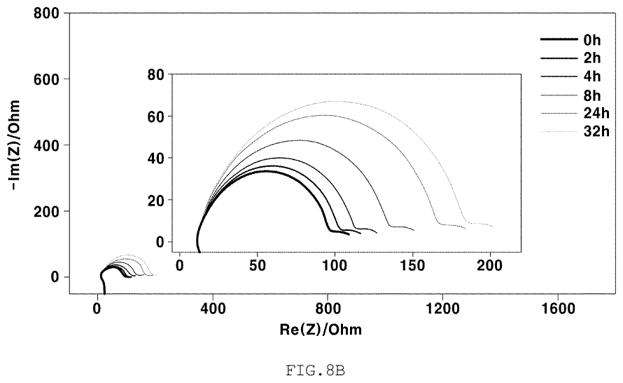

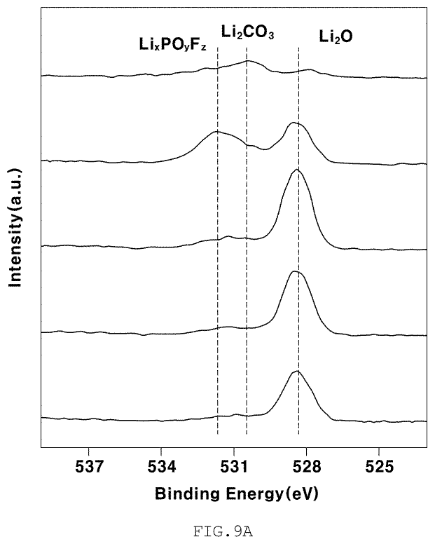

FIG. 8A shows a Nyquist plot obtained by pertaining electrochemical impedance spectroscopy on the symmetric cell prepared in Comparative Example 1. FIG. 8B shows a Nyquist plot obtained by performing electrochemical impedance spectroscopy on the symmetric cell prepared in Example 1.

Referring to FIG. 8A, the symmetric cell of Comparative Example 1 exhibited a continuous and rapid increase in impedance up to 32 hours after assembling the symmetrical cell. That is, the impedance was increased from about 800Ω (initial impedance) to about 1,500Ω (impedance after 32 hours of measurement). Referring to FIG. 8B, the symmetric cell of Example 1 exhibited a stable low interface impedance of 100Ω to 180Ω maintained throughout the rest period. That is, in the symmetrical cell of Example 1, it is seen that since the electrolyte did not pass through the interfacial layer, the electrolyte and the lithium metal did not react with each other.

In order to verify the protective effect of the interfacial layer, the symmetric cells of Example 1 and Comparative Example 1 were charged and then disassembled, and each anode was analyzed by X-ray photoelectron spectroscopy (XPS). Each specimen was washed with anhydrous dimethoxyethane before analysis to prevent residual salts from affecting the results.

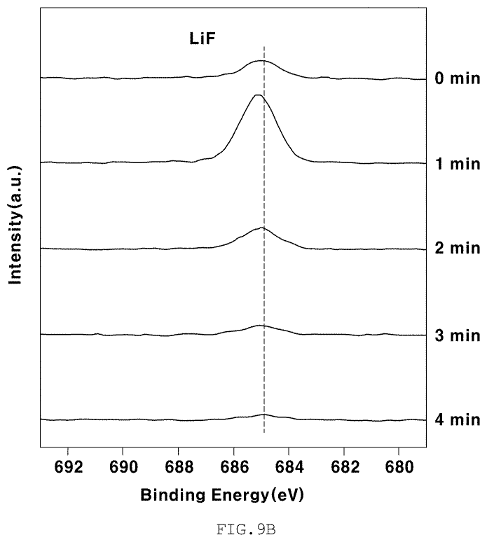

FIG. 9A shows an O1s spectrum obtained by performing X-ray photoelectron spectroscopy (XPS) on the symmetric cell of Comparative Example 1, and FIG. 9B shows an F1s spectrum obtained by performing X-ray photoelectron spectroscopy on the symmetric cell of Comparative Example 1.

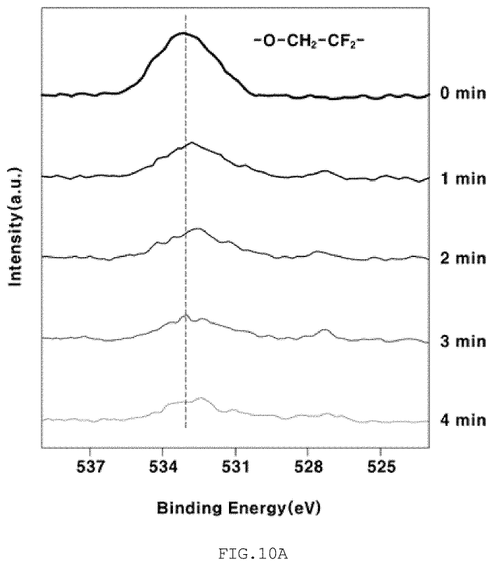

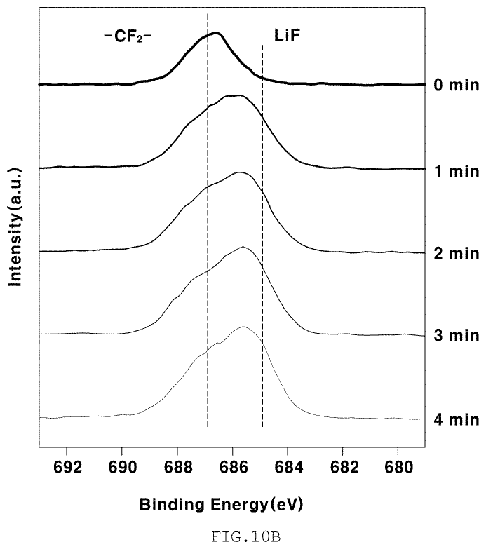

FIG. 10A shows an O1s spectrum obtained by performing X-ray photoelectron spectroscopy on the symmetric cell of Example 1. FIG. 10B shows an F1s spectrum obtained by performing X-ray photoelectron spectroscopy on the symmetric cell of Example 1.

Referring to FIGS. 9A and 9B, Comparative Example 1 shows a high content of the compound derived from the electrolyte. For example, LiₓPO_{y}F_{z} and LiF are the decomposition products of LiPF₆, which is a lithium salt. In addition, Li₂CO₃ and Li₂O are derived from a carbonate solvent.

Referring to FIGS. 10A and 10B, Example 1 does not show the compound derived from the electrolyte. In Example 1, the peaks due to 2,2,3,3-tetrafluoro-1,4-butanediol (FBD) are predominantly shown. That is, in Example 1, since the interfacial layer blocks contact between the electrolyte and the lithium metal, the electrolyte does not decompose.

Referring to FIG. 10B, LiF is found in Example 1. However, considering that LiₓPO_{y}F_{z} is not found in FIG. 10A, it is seen that the LiF found in Example 1 is not attributable to decomposition of the electrolyte but to a controlled reaction between the 2,2,3,3-tetrafluoro-1,4-butanediol (FBD) and the lithium metal. In addition, in Example 1, LiF is uniformly distributed at different depths. This uniformity means that the reaction between the 2,2,3,3-tetrafluoro-1,4-butanediol (FBD) and the lithium metal is well regulated. It is advantageous for the reversibility of lithium metal.

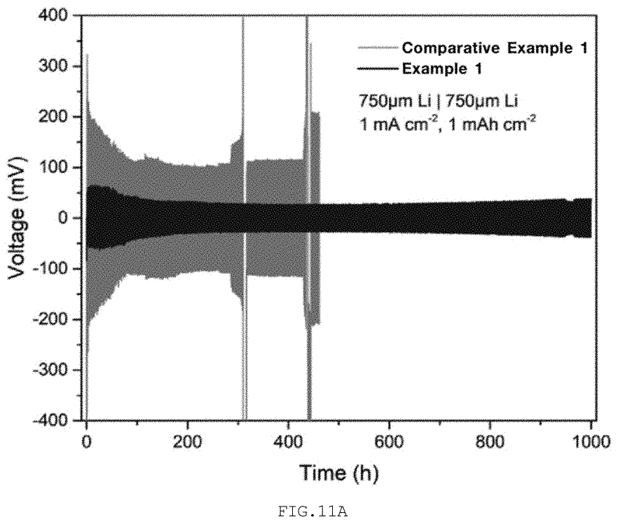

FIG. 11A shows cycling performance of the symmetric cells according to Example 1 and Comparative Example 1. FIG. 11B shows an enlarged view of the periodic performance for a specific period shown in FIG. 11A.

The symmetric cell of Example 1 reliably operates for more than 1,000 hours, while the symmetric cell of Comparative Example 1 exhibits a severe over potential after 300 hours or more of the operation and stops the operation thereof after about 460 hours of the operation. Referring to FIG. 11B, the over-potential value of the symmetric cell of Example 1 is about 25 mV, which is four times lower than the over-potential value (100 mV) of the symmetric cell of Comparative Example 1. That is, the symmetric cell of Example 1 exhibits four times lower polarization. It is confirmed that the interfacial layer disclosed in the present disclosure can effectively prevent the electrolyte from corroding lithium.

### Example 2: Li|Cu Half-Cell

The solution of FIG. 5 obtained in Preparation Example was applied to a copper current collector having a thickness of about 25 μm and dried to form an interfacial layer. The copper current collector was attached to one surface of a separator such that the interfacial layer is in contact with the separator. A lithium metal layer having a thickness of about 750 μm was attached to another surface of the separator. The same electrolyte as in Example 1 was injected into the separator to produce a half cell.

### Comparative Example 2

A half-cell was manufactured as in Example 2 except that the interfacial layer was not formed.

The half-cell of Example 2 and Comparative Example 2 were operated so that lithium is formed on the copper current collector. The half-cells were disassembled and the deposition form of the lithium was analyzed. The specimen of Example 2 was washed with anhydrous dimethoxyethane to remove the interfacial layer and then analyzed.

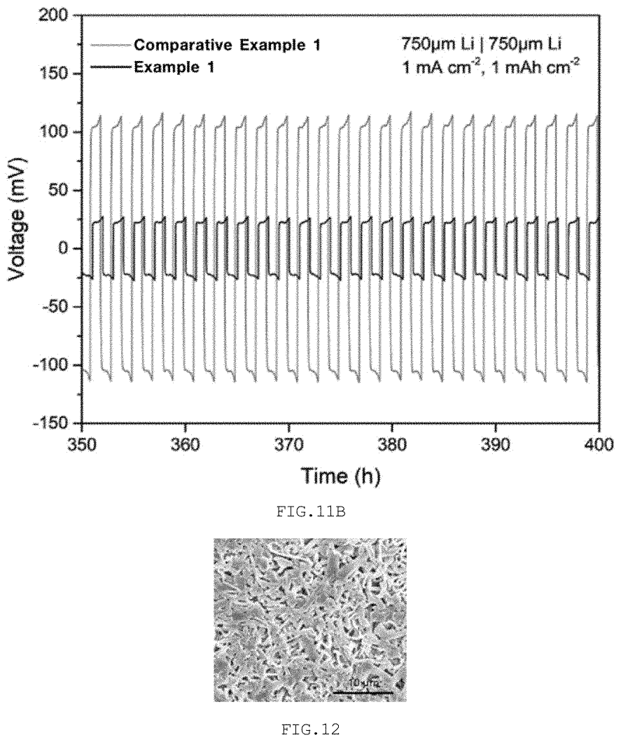

FIG. 12 shows a scanning electron microscope (SEM) image of lithium deposited in the half cell of Comparative Example 2. Comparative Example 2 shows that dendritic lithium has grown.

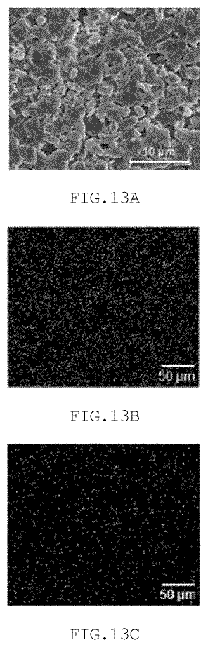

FIG. 13A shows an SEM image of lithium deposited in the half cell of Example 2. It is seen that no needle-like lithium filaments are found in the deposited lithium. The deposited lithium has a blunt shape, which means that the interfacial layer effectively inhibits the growth of dendritic lithium.

FIG. 13B shows an energy-dispersive X-ray spectroscopy (EDS) analysis result for elemental fluorine for the half cell of Example 2. FIG. 13C shows an energy-dispersive X-ray spectroscopy (EDS) analysis result for elemental aluminum for the half cell of Example 2. Although the interfacial layer was mostly removed by washing with anhydrous dimethoxyethane, it is seen that the fluorine element and the aluminum element were uniformly distributed on the deposited lithium. This reveals that the interfacial layer can be uniformly foiled on the anode material layer.

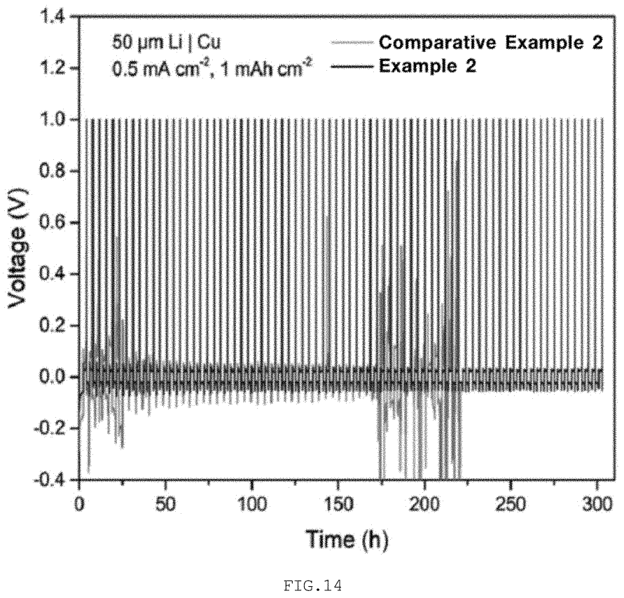

FIG. 14 shows cycling performance of the symmetric cells of Example 2 and Comparative Example 2. Comparative Example 2 shows severe fluctuations. In particular, passivation ability of a naturally formed solid electrolyte interphase layer is deteriorated in light of the large fluctuations are shown in the initial and last stages of charging and discharging. Example 2, on the other hand, shows more stable line-of-sight flatness and longer lifespan.

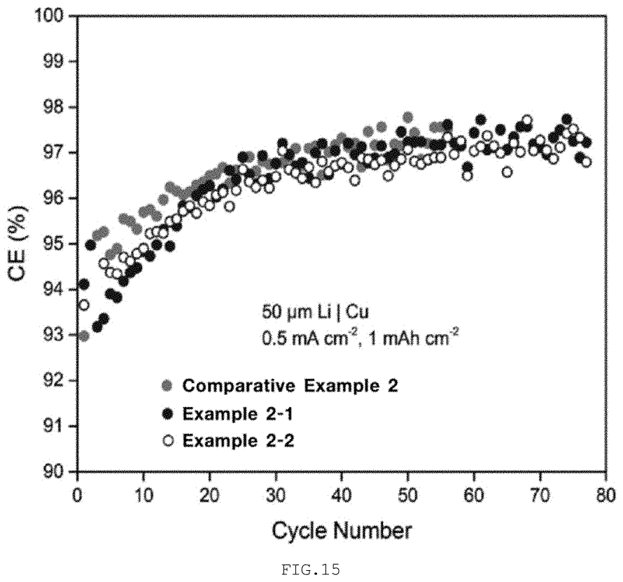

FIG. 15 shows the Coulomb efficiency for each of the half cells of Example 2 and Comparative Example 2. In Example 2, two identical specimens were prepared for the measurement. The two specimens are denoted by Example 2-1 and Example 2-2, respectively in FIG. 15. Example 2 shows an overall high Coulomb efficiency of about 97.5% or higher. On the other hand, Comparative Example 2 shows a slightly higher Coulomb efficiency during the initial 10 cycles, such a result is attributable to the voltage fluctuations in the initial stage of FIG. 14. Based on the region showing the flat voltage, Example 2 exhibits a higher Coulomb efficiency than Comparative Example 2.

### Example 3

A lithium metal having a thickness of about 50 μm was prepared as an anode material layer. The solution of FIG. 5B obtained in Preparation Example was applied onto the lithium metal and dried to form an interfacial layer. An anode material layer was attached to one surface of a separator such that the interfacial layer is in contact with the separator. A cathode including NCM811, which is a cathode active material, is attached to another surface of the separator. The loading amount of the cathode active material was adjusted to about 3.5 mAh·cm⁻². A full cell was prepared by injecting 4M LiFSI in dimethylether (DME) as an electrolyte into the separator in an amount of about 2.8 μL·mAh⁻¹.

### Comparative Example 3

A full cell was prepared in the same manner as in Example 3 except that the interfacial layer was not formed.

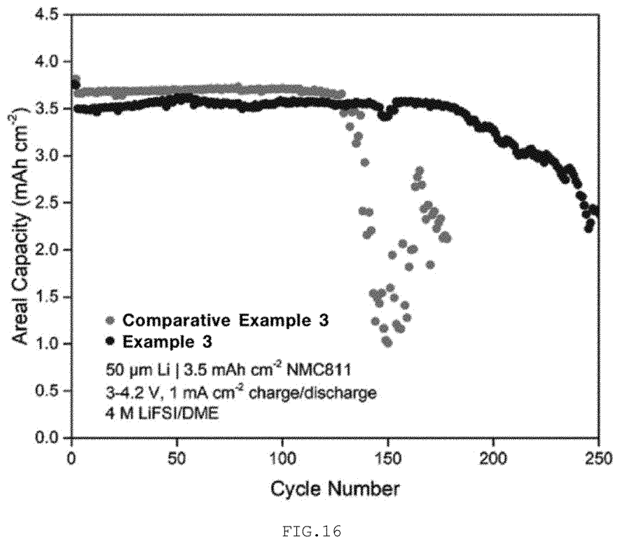

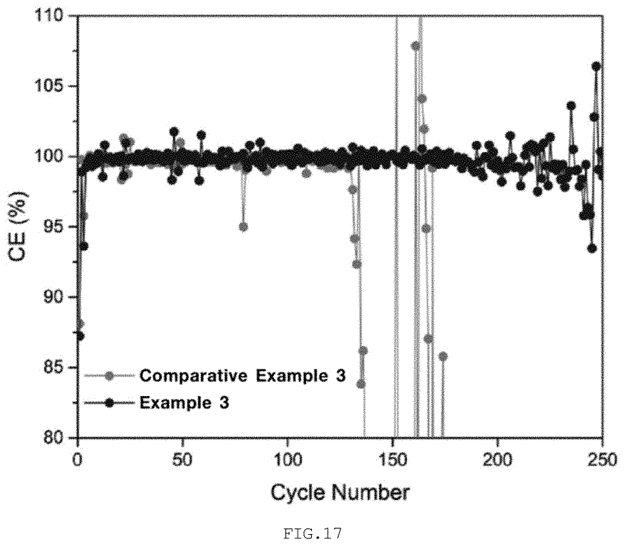

FIG. 16 shows cycling performance of the full cells according to Example 3 and Comparative Example 3. FIG. 17 shows Coulomb efficiency of the full cells according to Example 3 and Comparative Example 3. Each full cell was charged and discharged with a current of 1 mA·cm⁻² in the voltage range of 3V to 4.2V.

Referring to FIGS. 16 and 17, the cell of Comparative Example 3 rapidly collapses after about 130 cycles of charging and discharging, and the Coulomb efficiency fluctuates significantly. This is due to the side reaction of the lithium metal with the electrolyte and the resulting decomposition of the electrolyte.

The cell of Example 3, on the other hand, reliably operates for 200 cycles of charging and discharging, and then exhibits a gradual decrease in capacity until reaching 250 cycles. This slow disintegration demonstrates the effectiveness of the interfacial layer. In addition, the Coulomb efficiency of the cell of Example 3 is maintained at 100% for 230 cycles.

Although examples and experimental examples according to the present disclosure have been described for illustrative purposes, those skilled in the art will appreciate that various modifications, additions and substitutions are possible, without departing from the scope and spirit of the disclosure as defined by the appended claims,

What is claimed is:

1. An anode for lithium secondary battery, comprising:
an anode current collector layer;
an anode material layer disposed on the anode current collector layer and comprising lithium metal; and
an interfacial layer disposed on the anode material layer and comprising a coordination compound;
wherein the coordination compound comprises a complex ion and a counter ion,
the complex ion comprises a central cation; and
a ligand coordinated to the central cation and comprising a fluorocarbon moiety having 1 to 4 carbon atoms, and
the counter ion comprises a lithium ion.

2. The anode of claim 1, wherein the coordination compound has a crystalline or semicrystalline structure.

3. The anode of claim 1, wherein the coordination compound has an orthorhombic crystal structure.

4. The anode of claim 1, wherein the complex ion comprises a plurality of central cations connected to each other via the ligand.

5. The anode of claim 1, wherein the central cation comprises a cation of a metal, and
the metal comprises at least one of Al, Zn, Co, Ni, Cu, Fe, or any combination thereof.

6. The anode of claim 1, wherein the central cation comprises Al³⁺.

7. The anode of claim 1, wherein the coordination compound comprises an amount of about 2% to 7% by weight of the counter ion.

8. The anode of claim 1, wherein the interfacial layer has a Young's modulus of about 30 GPa to 40 GPa and a hardness of about 2 GPa or more.

9. The anode of claim 1, wherein the interfacial layer has a lithium ion conductivity of about 9×10⁻⁶ S/cm or more.

10. The anode of claim 1, wherein the interfacial layer exhibits a peak at a binding energy of about 531 ev to 534 eV in O1s spectrum of X-ray photoelectron spectroscopy (XPS) analysis.

11. The anode of claim 1, wherein the interfacial layer exhibits a peak at a binding energy of about 685 eV to 687 eV in F1s spectrum of X-ray photoelectron spectroscopy (XPS) analysis.

12. A lithium secondary battery comprising:
an anode for the lithium secondary battery, the anode comprising:
an anode current collector layer;
an anode material layer disposed on the anode current collector layer and comprising lithium metal; and
an interfacial layer disposed on the anode material layer and comprising a coordination compound;
wherein the coordination compound comprises a complex ion and a counter ion,
the complex ion comprises a central cation; and
a ligand coordinated to the central cation and comprising a fluorocarbon moiety having 1 to 4 carbon atoms, and
the counter ion comprises a lithium ion;
a cathode; and
an electrolyte interposed between the anode and the cathode.

13. A method of manufacturing an anode for a lithium secondary battery, the method comprising:
preparing a solution comprising a coordination compound by adding a precursor of the coordination compound to a solvent and reacting the precursor;
forming an interfacial layer by coating the solution onto a substrate and drying the solution; and
manufacturing an anode comprising an anode current collector layer, an anode material layer disposed on the anode current collector layer and comprising a lithium metal, and the interfacial layer disposed on the anode material layer,
wherein the coordination compound comprises a complex ion and a counter ion,
the complex ion comprises a central cation and a ligand coordinated to the central cation and comprising a fluorocarbon moiety having 1 to 4 of carbon atoms, and
the counter ion comprises a lithium ion.

14. The method of claim 13, wherein the precursor comprises:
a first reactant comprising precursors of the central cation and the counter ion, and
a second reactant comprising a precursor of the ligand.

15. The method of claim 14, wherein the first reactant comprises a compound represented by LiMHₓ, wherein M comprises at least one of Al, Zn, Co, Ni, Cu, Fe, or any combination thereof, and x is a valence number of M.

16. The method of claim 14, wherein the second reactant comprises a compound represented by Formula 1: 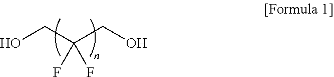
wherein n is an integer of 1 to 4.

17. The method of claim 13, wherein the solvent comprises at least one of 1,2-dimethoxyethane, tetrahydrofuran, or any combination thereof.

18. The method of claim 13, wherein the coordination compound has an orthorhombic crystal structure.

19. The method of claim 13, wherein the coordination compound comprises an amount of about 2% to 7% by weight of the counter ion.

20. The method of claim 13, wherein the interfacial layer has a Young's modulus of about 30 GPa to 40 GPa, a hardness of about 2 GPa or more, and a lithium ion conductivity of about 9×10⁻⁶ S/cm or more.
